(19) United States
(12) Patent Application Publication
(10) Pub. No.: US 2011/0115208 A1
(43) Pub. Date: May 19, 2011

(54) ANNIVERSARY CALENDAR

(76) Inventor: Francesco Pedrioni, Manerbio (IT)

(21) Appl. No.: 13/003,991

(22) PCT Filed: Jul. 9, 2009
(86) PCT No.: PCT/IB2009/006220

§ 371 Date: Jan. 13, 2011

(30) Foreign Application Priority Data
Jul. 15, 2008 (IT) CR2008A000014

(51) Int. Cl. B42D 5/04

(52) U.S. Cl. 283/2

(57) ABSTRACT

In the field of calendars the rule is a unit representation of the year from the 1 January—the first day of the year—till the 31 December—the last day—(an objective representation of time which follows the Gregorian calendar); the Anniversary Calendar, on the contrary, represents the annual period (of 365 days or, in case of leap years, of 366 days, considering that the solar year lasts 365 days, 5 hours and 49 minutes) starting from a fixed day and month (of the Gregorian calendar) in which an event is celebrated, until the eve of the annual anniversary day of the same event. The annual period so represented is divided up into 12 rectangles (each one containing 31 boxes). The first day of each rectangle will have the same number of the day of the event, except few exceptions indicated in the detailed description.

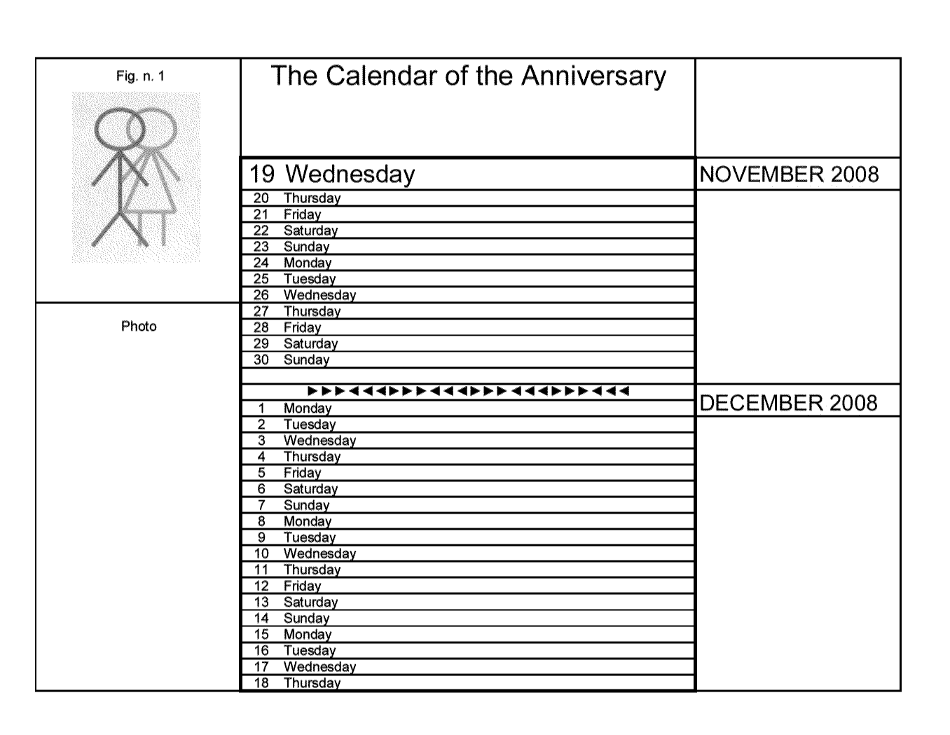

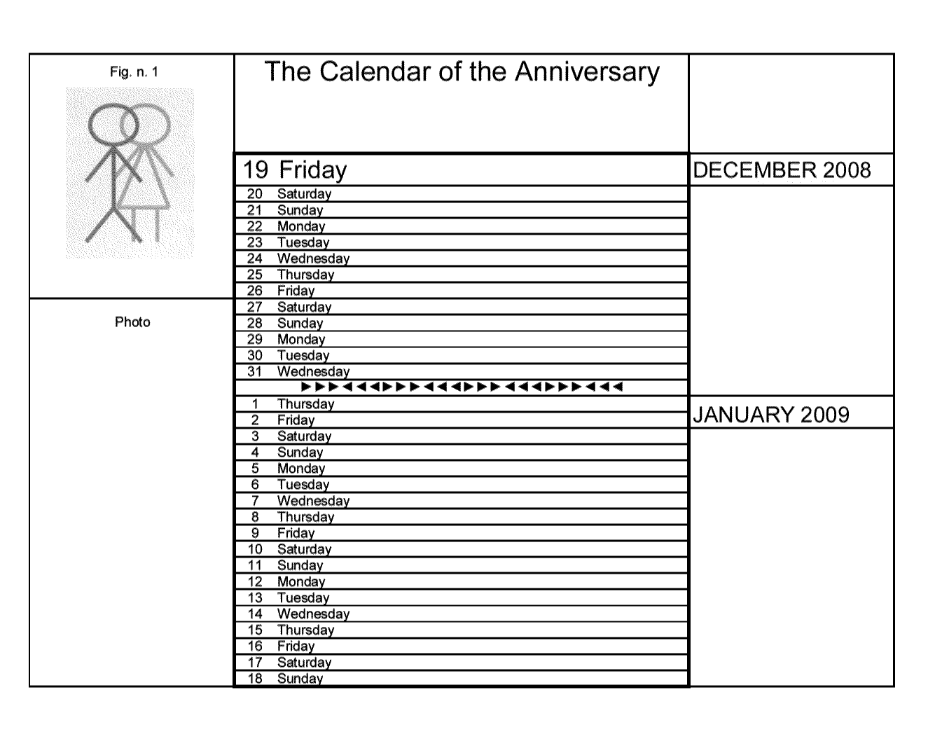

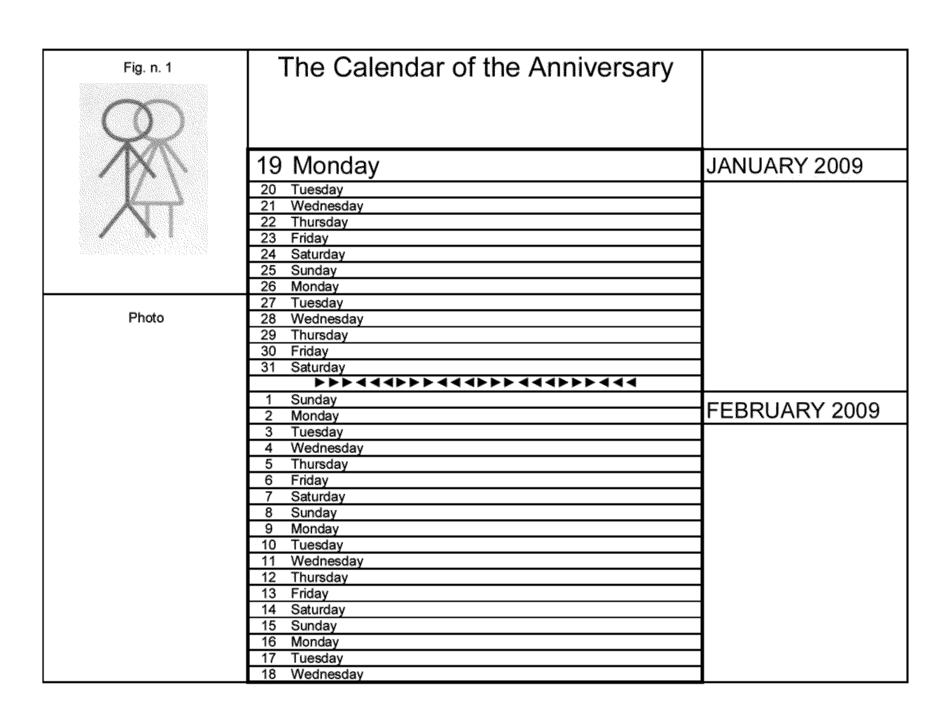

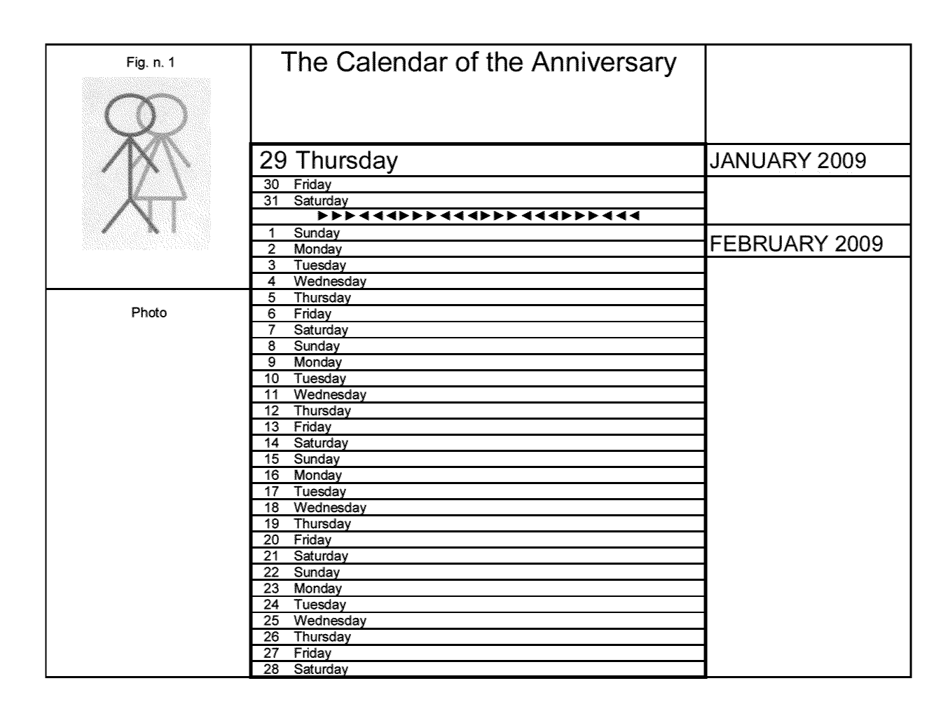

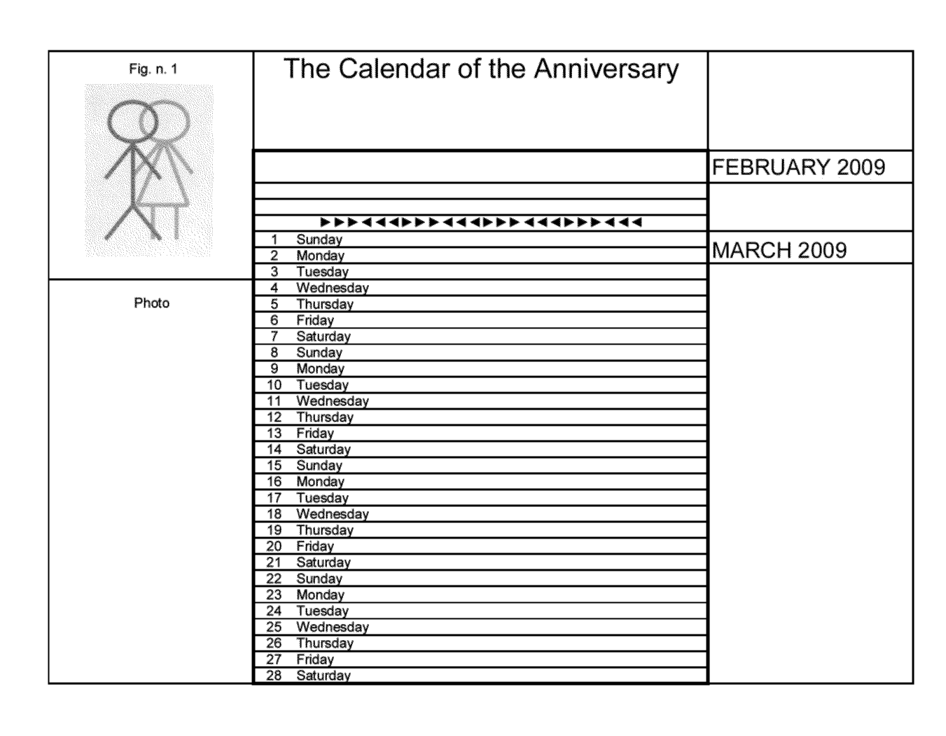

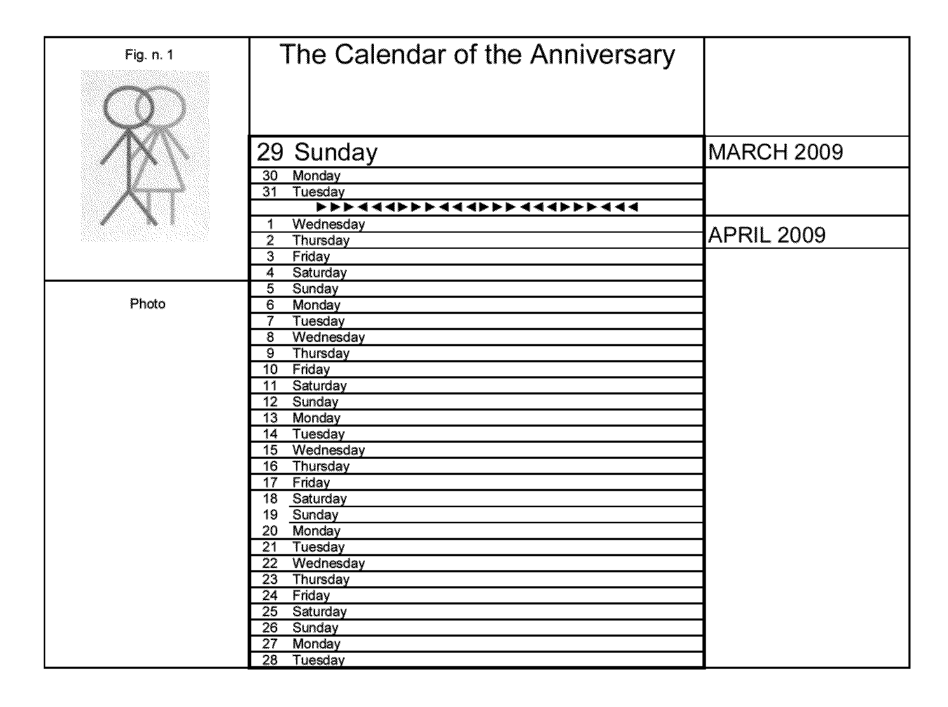

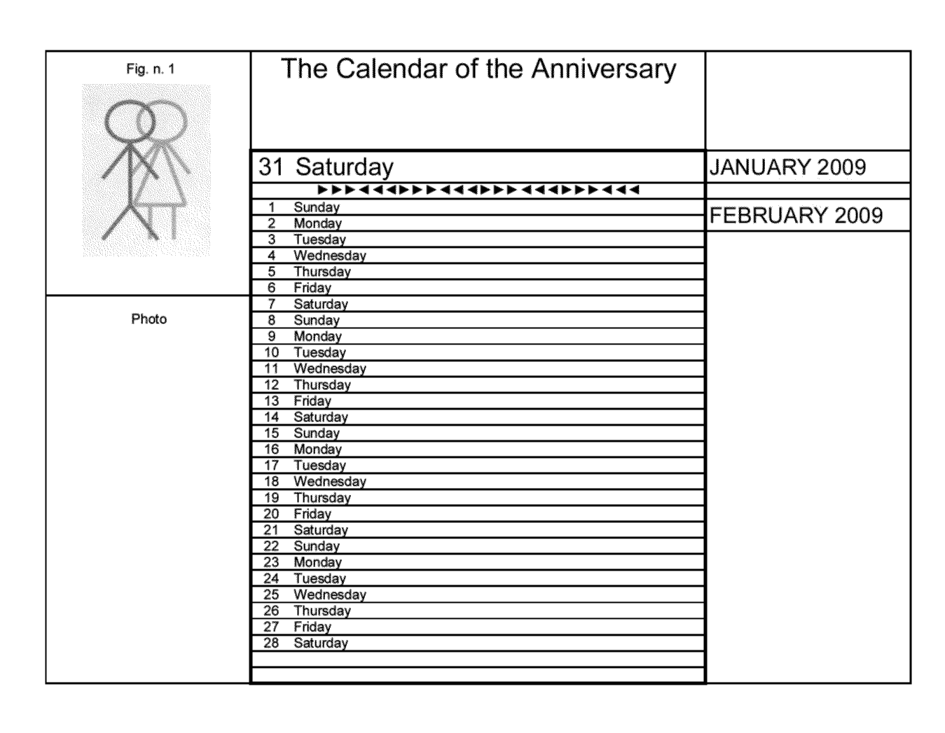

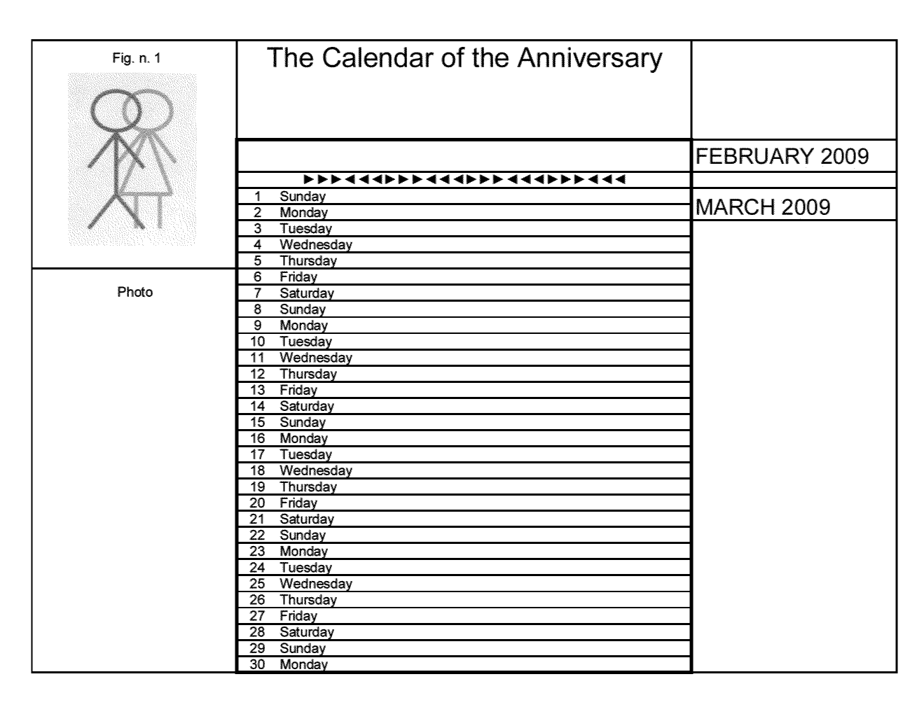

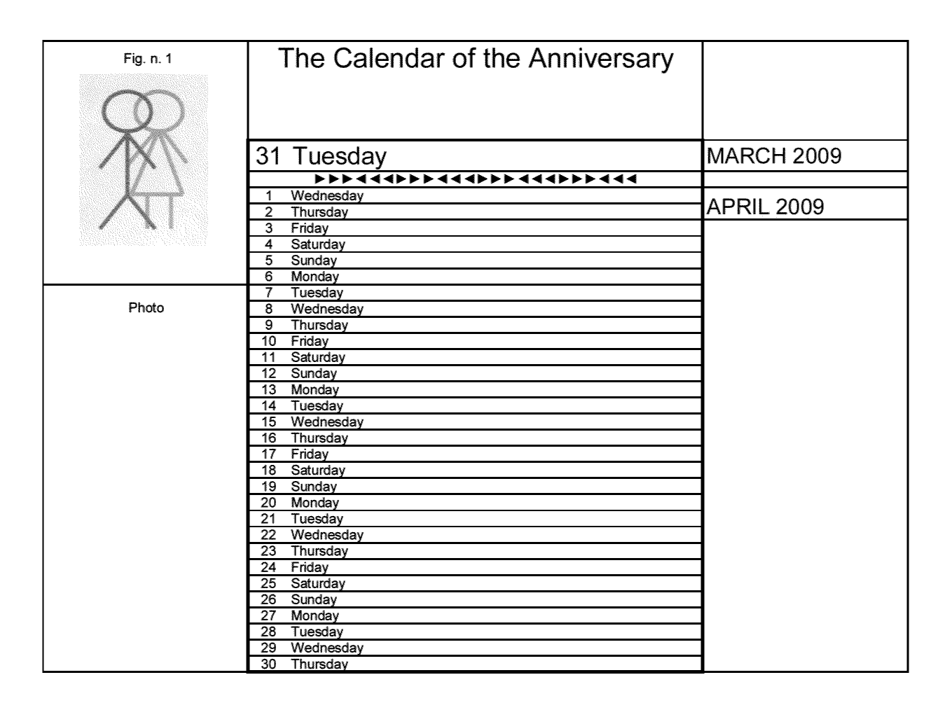

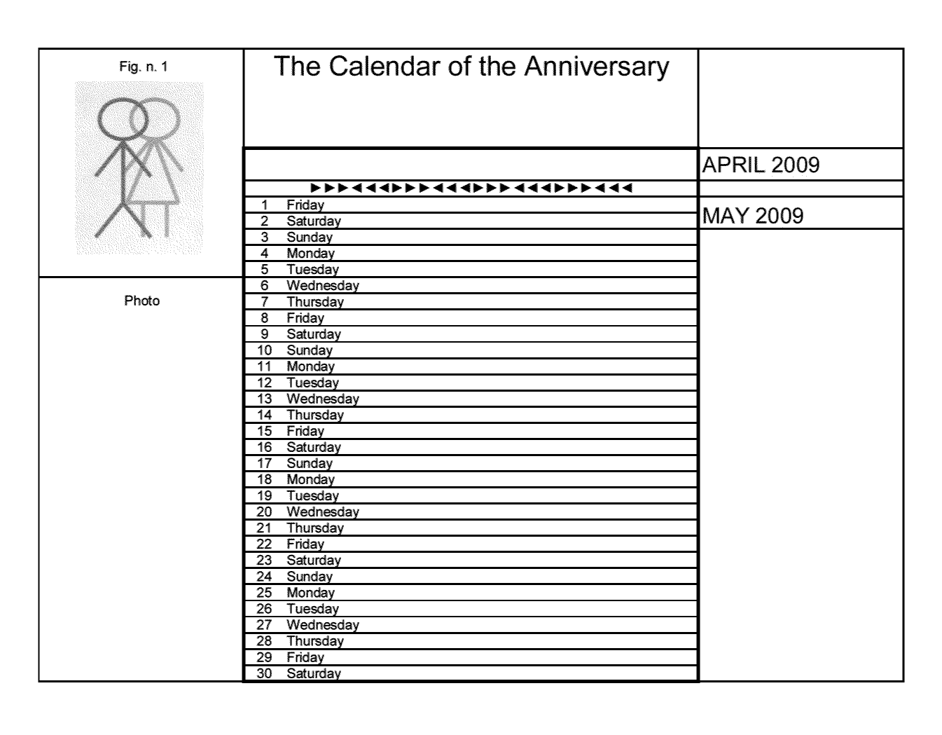

### TECHNICAL FIELD AND PRE-EXISTING TECHNIQUE

In the field of calendars the rule is a unit representation of the year from the 1 January—the first day of the year—till the 31 December—the last day—(an objective representation of time which follows the Gregorian calendar for civil use); the Anniversary Calendar, on the contrary, represents the year length (365 days or, in case of leap years, 366 days, considering that the solar year lasts 365 days, 5 hours and 49 minutes) starting from a fixed day and month (of the Gregorian calendar for civil use) in which an event is celebrated, until the eve of the annual anniversary of the same event. The year length so represented is divided up into 12 rectangles in which, for each one, the first day will have the same number of the day of the event, except few exceptions indicated in the detailed description.

### MEMORY, COMMUNICATION AND CALCULATION PURPOSES

The date of an event is considered important in so far as a subject has a relationship with this event; the date of birth, of wedding, and so on is usually well impressed in the memory of the person involved in the event, but it can be easily forgotten by other people (and sometimes, depending on the kind of event, even by the involved person) just for absent-mindedness, causing a kind of sorrow to the involved person who may suffer if one of his colleagues cannot remember his birthday or anything else. And, since it is often embarrassing to try to give rise to a kind of memory awakening in relatives or friends, the presence of an Anniversary Calendar for example in the office (innocently put on the bureau or hung on the wall) can be the solution of the problem.

This is also true in the family orbit for a spouse, a parent, a child and so on. The calculation of the missing months or days before the anniversary to celebrate is moreover much easier.

### EXPLICATION OF THE INVENTION

The proposed system consists in representing the length of a year from the date of the event till the following eve of the same event, dividing up the time (365 days or 366 days in case of leap years) into twelve rectangles: the first rectangle will bear the beginning date which corresponds to the day and month of the anniversary and the other 11 will begin with the first day having the same number of the event day, but with a different month.

Example: if we choose 15 Aug. 2008 as an event date, our first rectangle will be from 15 August to 14 Sep. 2008, the second rectangle from 15 September to 14 Oct. 2008, the third rectangle from 15 Oct. 2008 to 14 Nov. 2008, the fourth rectangle from 15 Nov. 2008 to 14 Dec. 2008, the fifth rectangle from 15 Dec. 2008 to 14 Jan. 2009, the sixth rectangle from 15 Jan. 2009 to 14 Feb. 2009, the seventh rectangle from 15 Feb. 2009 to 14 Mar. 2009, the eighth rectangle from 15 Mar. 2009 to 14 Apr. 2009, the ninth rectangle from 15 Apr. 2009 to 14 May 2009, the tenth rectangle from 15 May 2009 to 14 Jun. 2009, the eleventh rectangle from 15 Jun. 2009 to 14 Jul. 2009 and the twelfth rectangle, which will close the annual Anniversary Calendar from 15 Jul. 2009 to 14 Aug. 2009.

Each rectangle contains 31 (thirty-one) boxes in which a day has to be placed box after box, progressively, from top to bottom, following the days of the weeks and the months of the Gregorian calendar.

The Calendar begins with a first rectangle which will start with the day and month of the event we want to celebrate and this day will be represented in the first box of the rectangle; the first box of each rectangle will be bigger than the others for a better visibility; the following boxes contain the other consecutive days of the weeks, of the months, of the year up to the 31 box. The Calendar, after a 365-day course, ends with the 12 rectangle in which the last day corresponds to the eve of the event to celebrate.

Since we have to consider the system of the civil calendar adopted by all the countries of the world, the fact that every four years the number of days increases of a unit (365 days in a year become 366 in a leap year), the fact that only seven months out of twelve have got 31 days and the fact that the twelve rectangles contain (31×12=)372 boxes, that is to say 7 units more than the 365 days of a year (6 units in case of leap years), some boxes will be empty in order to maintain the purpose of beginning each rectangle with the number of the day in which the anniversary event falls, except in few cases in the rectangles following the first one where the first box will be empty, that is to say without the number of the day, when this calendar day does not exist in the Gregorian Calendar. This is the case of the days 29^{th}-30^{th}-31^{st}: February lacks these days, but it has the 29^{th} in leap years, while April, June, September and November, besides February, lack the day 31^{st}.

So, for an anniversary falling on the 29^{th} day of the month (any month of a normal year, except February in which the 29^{th} day exists only in leap years) the rectangle following the one which begins with January 29 (and ending with February 28 in the 31^{st} box) will have a first empty box (without any indications about the calendar day, because nonexistent) except in leap years, in which case this rectangle will begin with the number 29.

For an anniversary falling on the 30^{th} day of the month (any month except February which lacks this day) the rectangle following the one which begins with January 30 (and ending with February 28 in a normal year or February 29 in leap years in the 31^{st} box) will have a first empty square (without any indications about the calendar day, because nonexistent).

For an anniversary falling on the 31^{st} day of the month (any month with 31 days: January, March, May, July, August, October or December) the rectangles following the ones which begin with January 31, March 31, May 31, August 31 and October 31 will have a first empty box (without any indications about the calendar day, because nonexistent).

So, for an event falling on the 29th day of a month (any month except February in which this day does not exist) the Anniversary Calendar will have a first empty box in just one rectangle; in leap years, no empty boxes.

For an event falling on the 30th day of a month (any month, except February), the Anniversary Calendar will have a first empty box in just one rectangle.

For an anniversary falling on the 31^{st} day of the month (any month with 31 days: January, March, May, July, August, October or December) the Anniversary Calendar will have a first empty box in five rectangles.

After realizing 31 hypotheses (with the above-mentioned variations concerning leap years and numbers 29-30-31) in illustrating the Anniversary Calendar (one for each number from 1 to 31), according to the starting date (which indicates the day and the month of the chosen event to celebrate) from which the Anniversary Calendar begins and by which the numbering of the rectangles is fixed (the first rectangle for the 31 first boxes, starting from the box concerning the anniversary event), the solution for every anniversary event will be in rotation, with no modifications, that is to say: If we start for example with August 15 (date of the event to celebrate), the rectangle containing this date will be numbered with the number 1, while the second rectangle will begin with September 15 and so on until the twelfth rectangle which will begin with July 15 and will end with August 14 of the following year.

If instead we start for example with September 15 (date of the event to no celebrate), the rectangle containing this date will be numbered with the number 1, while the second rectangle will begin with October 15 and so on until the twelfth rectangle which will begin with August 15 and will end with September 14 of the following year.

It is obvious that only if the date of the event falls on January 1, the twelfth rectangle will end with December 31 of the same year.

Representation—In order to facilitate the comprehension of the link between the setting of the Anniversary Calendar and the event that the calendar wants to highlight, on the top margin of the page (on which one or more rectangles of the Anniversary Calendar are reproduced), on the left, there is a space with two stylized images of a man and a woman (picture n. 1), partially superimposed, which are provided with a sticker where to put the photo of the subject or the subjects participating or interested in the event from which the calendar starts.

### SHORT DESCRIPTION OF THE ENCLOSED DRAWINGS

To illustrate the invention 10 sheets of drawings numbered from 1 to 10 are enclosed:

1^{st} example—for an Anniversary on 19 November (3 sheets or tables from number 1 to 3).

The sheet 1 (or table 1) reproduces the first rectangle of the Anniversary Calendar which begins with the day 19 of the month of November 2008 and ends with the day 18 of the month of December 2008; the sheet 2 (or table 2) reproduces the 2 rectangle which begins with the day 19 of the month of December 2008 and ends with the day 18 of the month of January 2009; the sheet 3 (or table 3) reproduces the 3 rectangle which begins with the 19 of the month of January 2009 and ends with the day 18 of the month of February 2009. The following rectangles will follow the same rules, so the 12 rectangle will close the annual period with 18 Nov. 2009, the last day.

2^{nd} example—for an Anniversary on 29 January (3 sheets or tables from number 4 to 6).

The sheet 4 (or table 4) reproduces the 1 rectangle of the Anniversary Calendar which begins with the day 29 Jan. 2009 and ends on 28 Feb. 2009; the sheet 5 (or table 5) reproduces the 2 rectangle which begins with three empty boxes (the 1^{st}, 2^{nd} and 3^{rd}, as February 2009 has not got the days 29^{th}, 30^{th} and pb 31^{st}) and ends on 28 March 2009; the sheet 6 (or table 6) begins with the day 29 March and ends with the day 28 April, and so on. The following rectangles will follow the same rules, so the 12 rectangle will begin with 29 December and it will end with 28 Jan. 2010. 3^{rd} example—for an Anniversary on 31 January (4 sheets or tables from number 7 to 10).

The sheet 7 (or table 7) reproduces the 1 rectangle of the Anniversary Calendar which begins with the day 31 Jan. 2009 and ends with two empty boxes (the 30^{th} and the 31^{st}, as February 2009 has not got the days 29^{th} and 30^{th}) following the last day of February (the 28^{th}); the sheet 8 (or table 8) reproduces the 2 rectangle which begins with an empty box (as February has not got the 31^{st} day) and ends with the 30 March; the sheet 9 (or table 9) reproduces the 3 rectangle which begins with 31 Mar. 2009 and ends on 30 Apr. 2009; the sheet 10 (or table 10) reproduces the 4 rectangle which begins with an empty box (as April has not got the 31^{st} day) and ends on 30 May. The following rectangles will follow the same rules, so the 12 rectangle will end with the last day of the Anniversary Calendar so celebrated (of 31 Jan. 2009) on 30 Jan. 2010.

### BEST WAY TO REALIZE THE INVENTION AND ITS APPLICABILITY

Under the title “The Anniversary Calendar”, in the space between the title itself and the beginning of the rectangle (in each sheet or table) there will be a rectangular opening in each sheet, except the last one. The wording concerning the event to celebrate is clearly indicated and the same event will be highlighted thanks to the rectangular opening in each sheet which allows the visibility of the wording related to the event, written on the last sheet or table and so clearly visible through the opening. A kind of wording can be for example “March 8—Women's day” for the Anniversary Calendar of the Women's day which falls on March 8; for example “November 19—My birthday” or “Our wedding”, and so on.

The best way to realize this invention is to print it on paper.

1-10. (canceled)

11. An anniversary calendar comprising:
a starting date;
an event to celebrate, said event to celebrate comprising a date, an anniversary day and an eve of said anniversary date
wherein said starting date is not a unique starting date but varies according to the date of the event to celebrate and wherein said anniversary calendar starts from the date of the event to celebrate and ends on the eve of said anniversary date.

12. The anniversary calendar of claim 11, wherein each day is represented by boxes and rectangles changing according to the starting date.

13. The anniversary calendar of claim 12, wherein said anniversary calendar is divided up into 12 rectangles.

14. The anniversary calendar of claim 12, wherein each rectangle contains 31 boxes and wherein said boxes are capable of containing days up to 31 consecutive days or up to the eve of the anniversary date.

15. The anniversary calendar of claim 13, wherein the rectangle containing the starting date is first.

16. The anniversary calendar of claim 13, wherein the rectangles following the first comprise 31 boxes, wherein box no. 1 contains only a number corresponding to said anniversary date, while box no. 31 of rectangle no. 12 contains only a number corresponding to the eve of said anniversary date.

17. The anniversary calendar of claim 2, wherein up to 12 rectangles are representable on a single page.

18. The anniversary calendar of claim 1 in any language for which there is a Gregorian calendar.
